(19) United States
(12) Patent Application Publication
(10) Pub. No.: US 2015/0023519 A1
(43) Pub. Date: Jan. 22, 2015

(54) HEADPHONE EXTENSION SYSTEM

(71) Applicant: IdeaVillage Products Corp., Wayne, NJ (US)

(72) Inventor: Greg E. Blonder, Summit, NJ (US)

(21) Appl. No.: 14/482,596

(22) Filed: Sep. 10, 2014

Related U.S. Application Data
(63) Continuation-in-part of application No. 13/815,538, filed on Mar. 8, 2013.
(60) Provisional application No. 61/875,778, filed on Sep. 10, 2013.

(51) Int. Cl. H04R 1/06

(52) U.S. Cl. CPC H04R 1/06
USPC 381/74

(57) ABSTRACT

In an embodiment, a music playing and listening apparatus comprising at least one speaker, at least one audio input receiver, at least one audio output interface at least one amplifier, and at least one power source.

### CROSS-REFERENCE TO RELATED APPLICATIONS

This application is a continuation-in-part of U.S. application Ser. No. 13/815,538, filed Mar. 8, 2013. This application claims the benefit of U.S. Provisional Application No. 61/875,778, filed on Sep. 10, 2013. U.S. application Ser. No. 13/815,538 and U.S. Provisional Application No. 61/875,778 are both hereby incorporated by reference in their entireties.

### TECHNICAL FIELD

Embodiments of the present disclosure relate to the field of audio devices and, more particularly, to a headphone or headset including an output port configured for connection with another audio playback device.

### BACKGROUND

In certain instances, a person may wish to share his or her audio listening experience with one or more other people. Conventionally, a user may share audio wirelessly via software that streams one music channel simultaneously to many WiFi or Bluetooth headsets. Many of these systems are expensive and difficult to configure. In addition, a user may connect the audio source to a standalone speaker or speaker system to share music with as many people as are within listening range.

In order for a user listening to audio via a conventional headphone to connect to another headphone for playback of a common audio source with both users wearing the headphones, the two headphones must be connected via “Y” splitter cable. In this regard, listening to the same audio via two headphones requires a user be equipped with and employ the “Y” audio cable. Moreover, a Y splitter is limited in that is may only be used to connect two headphones together. If a user wants to connect more than two headphones together, multiple Y cables are required.

Furthermore, even if multiple conventional headphones were connected using multiple Y cables or other form of connectivity, wearing headphones in a group is awkward when a large number of people are tethered together with cables which may tangle or limit movement. Additionally, since the headphones are connected in parallel, the source audio signal is split from the music player proportionately, limiting the number of units that may be daisy-chained before audio performance suffers.

### SUMMARY

In an embodiment, a music playing and listening apparatus comprises at least one speaker, at least one audio input receiver, at least one audio output interface, at least one amplifier, and at least one power source. In another embodiment a music playing and listening apparatus is configured wherein the audio input receiver is adapted to receive an audio plug. In a further embodiment, a music playing and listening apparatus an audio input receiver is adapted to receive a wireless signal. In yet another embodiment, a music playing and listening apparatus is configured wherein an audio output interface is adapted to receive an audio plug. In still another embodiment, a music playing and listening apparatus includes an audio output interface adapted to transmit a wireless signal. In yet a further embodiment, a music playing and listening apparatus where in said audio output interface is configured to detect the presence of an external audio device. In still another embodiment, a music playing and listening apparatus whereupon detection of an audio plug the amplifier is powered on and the input signal) is routed through the amplifier before presentation to the audio output interface. In an even further embodiment, a music playing and listening apparatus is a headphone, said headphone having at least two listening modes.

In still a further embodiment, a music playing and listening apparatus comprising at least one speaker, said speaker having at least two listening modes, at least one audio input receiver, at least one audio output interface, at least one amplifier and at least one power source.

In yet another embodiment, a music playing and listening apparatus comprising a headband having opposing ends, at least two connectors, each of said connectors having at least two arms, a first arm being shorter than a second arm, at least two speakers, each of said speakers having opposing sides and comprising an audio output element on a first side and a compartment on a second side, said first and second arms of each of said connectors being pivotally attached to a portion of each of said speakers to thereby allow rotation of said speakers, each of said audio output elements of each of said speakers generally face one another during a first music listening mode, each of said speakers being rotatable about said first and second arms of each of said connectors to thereby allow each of said audio output elements of each of said speakers to turn away from one another during a second music playing mode; the rotation of said speakers allowing for changes in modes, at least one audio input receiver, at least one audio output interface, at least one amplifier, and at least one power source.

### BRIEF DESCRIPTION OF THE DRAWINGS

The accompanying drawings are included to provide a further understanding of the present disclosure. These drawings are incorporated in and constitute a part of this specification, illustrate one or more embodiments of the present disclosure and together with the description, serve to explain the principles of the present disclosure.

FIG. 1 is a perspective view of the apparatus of the present disclosure in a music listening mode on a user's head;

FIG. 2 is a perspective view of the apparatus of FIG. 1 in a music playing mode around a user's neck;

FIG. 3 is a perspective view of the apparatus of FIG. 1 in a music playing mode when the apparatus is place on a surface;

FIG. 4 is a perspective view of the present disclosure with an input cable;

FIG. 5 is a perspective view of two extendable headphones connected together for playback from a common audio source;

FIG. 6 is a perspective view of three extendable headphones connected together for playback from a common audio source;

FIG. 7 is a perspective vie of the present disclosure receiving an audio source that is then passed through a buffer amplifier; and

FIG. 8 is a perspective view of the present disclosure with a removable cable.

Among those benefits and improvements that have been disclosed, other objects and advantages of this disclosure will become apparent from the following description taken in conjunction with the accompanying drawings. The drawings constitute a part of this specification and include exemplary embodiments of the present disclosure and illustrate various objects and features thereof.

### DETAILED DESCRIPTION

As required, detailed embodiments of the present disclosure are disclosed herein; however, it is to be understood that the disclosed embodiments are merely exemplary of the disclosure that may be embodied in various forms. The figures are not necessarily to scale, some features may be exaggerated to show details of particular components. Therefore, specific structural and functional details disclosed herein are not to be interpreted as limiting, but merely as a basis for the claims and as a representative basis for teaching one skilled in the art to variously employ the present disclosure.

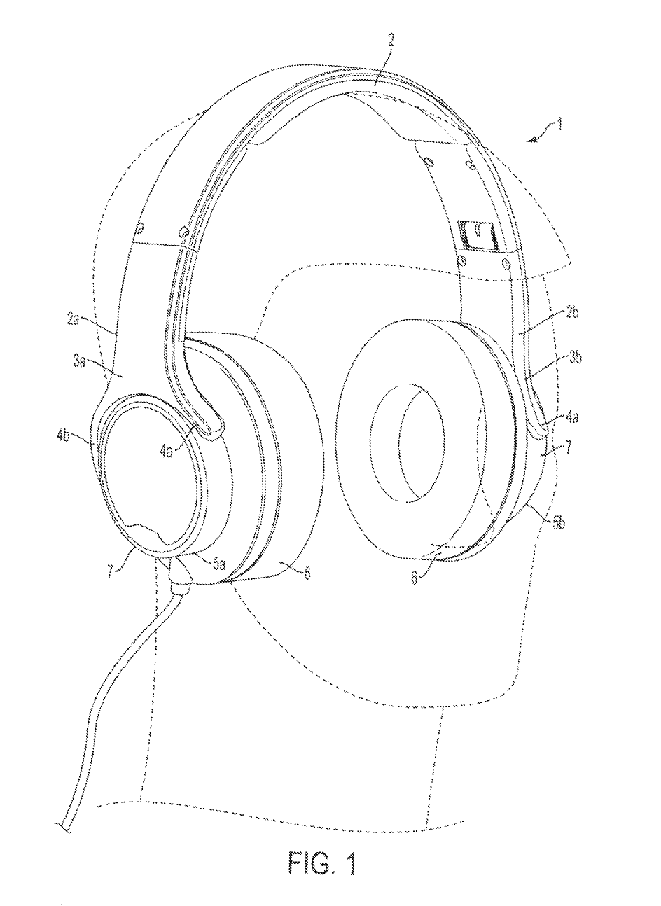

FIG. 1 illustrates the music listening and playing apparatus 1 of the present disclosure. The apparatus comprises a headband 2 having opposing ends, 2a and 2b respectively; at least two connectors, 3a and 3b respectively, each of the connectors has at least two arms, 4a and 4b respectively. The first arm 4a is shorter than a second arm 4b.

The apparatus 1 further comprises at least two speakers, 5a and 5b respectively, each of the speakers having opposing sides and comprising an audio output element 6 on a first side and a compartment 7 on a second side. The first and second arms, 4a and 4b, of each of the connectors is pivotally attached to a portion of each of the speakers, 5a or 5b, to thereby allow rotation of said speakers. Each of the audio output elements 6 of each of the speakers, 5a and 5b, generally face one another during a first music listening mode. In the music listening mode, the headband 2 is situated around the user's head and the audio output element 6 of each of the speakers, 5a and 5b, are generally facing the user's ears.

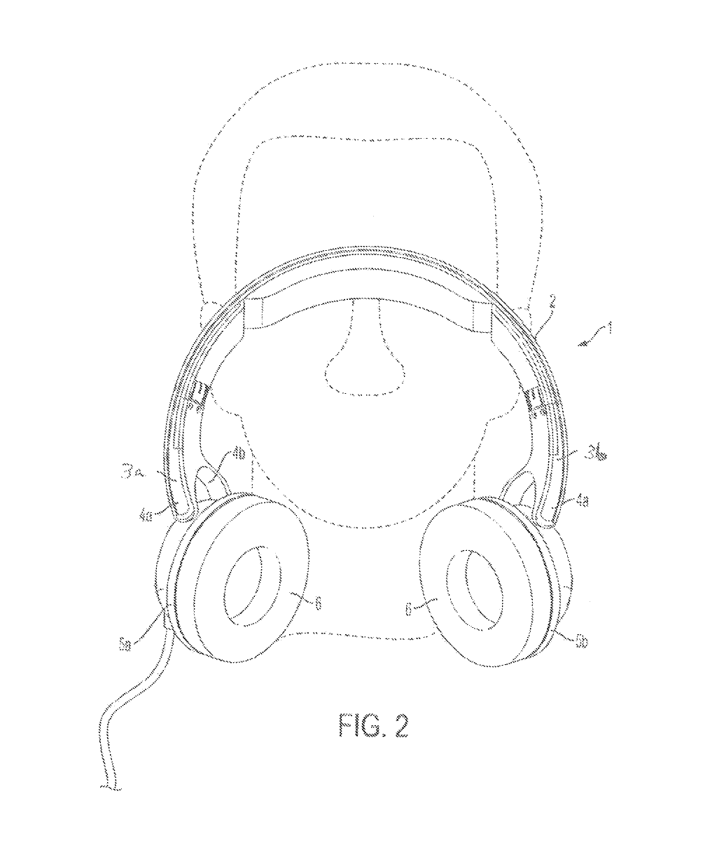

FIG. 2 depicts the second music playing mode of the apparatus 1 of the present disclosure. The apparatus 1 may be placed around the user's neck. Each of the speakers, 5a and 5b, are rotatable about the first and second arms, 4a and 4b, of each of the connectors, 3a and 3b, to thereby allow each of the audio output elements 6 of each of the speakers, 5a and 5b, to turn away from one another during the second music playing mode. The rotation of the speakers, 5a and 5b, allows for changes in modes.

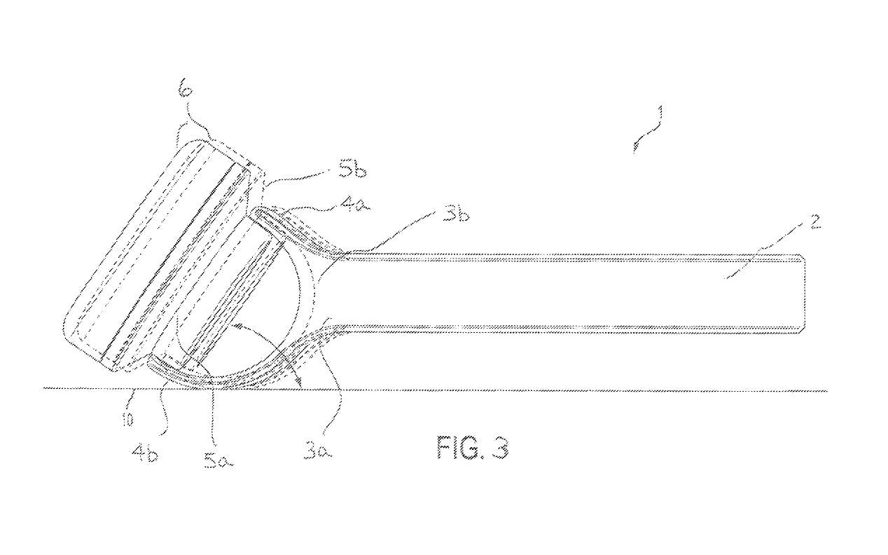

FIG. 3 shows another music playing mode where the apparatus 1 is set on a surface and the headband 2 is generally parallel to the surface 10 and the speakers, 5a and 5b, are designed to be rotated about the first and second arms, 4a and 4b, of each of the connectors, 3a and 3b, to allow the audio output elements 6 of each of the speakers, 5a and 5b, to generally face away from the surface 10 during the second music playing mode.

When the axle is not rotated and the product is worn as a headphone, the mode switch connects the left audio channel directly to the left speaker, and the right audio channel to the right speaker, and does not route power to the amplifier. The music device powers the acoustic transducer directly. However, once the enclosures are rotated by more than 30 degrees, the two 3PDT switches are thrown closed. This now routes the left audio signal to the left amplifier and the output of the left amplifier to the left speaker (and similarly for the right channel). It also provides power to the amplifier by running the power through the right enclosure switch in series—thus assuring both switches must be closed (and thus the speakers aimed safely away from the ears) before energizing the amplifier.

There are other variations and embodiments of the circuit. In another embodiment, the mode switch could contain one input and one output, used to trigger a solid state relay that provides all the aforementioned audio and power routing. In a further embodiment, the mode switch might be used to control the volume level, so it is low as a headphone and high as a speaker. This disclosure can be used with any applicable circuitry and is not limited to the exemplary circuitry presented herein.

The present disclosure relates to a headphone (referenced to herein as an “extendable headphone”) including an output interface or output jack (herein the “extension jack” or “extension port”) configured for connecting the headphone to at least a second headphone for the scalable playback of audio from a common audio source. A headphone so configured shall herein be referred to as an “extendable headphone”. The extendable headphone may be a “convertible headphone” capable of converting from a wearable headphone to a speaker. In an embodiment, the extendable headphone includes an amplifier within at least one speaker housing which is activated by twisting or turning the speaker housing into a particular position (e.g., the extendable headphone may be placed in speaker mode by twisting the headphone enclosures away from the eats to convert the headphone into an externally-directed amplified speaker). U.S. patent application Ser. No. 13/815,538, filed on Mar. 8, 2013, the entirety of which is hereby incorporated by reference herein, discloses an exemplary convertible headphone, according to embodiments of the present disclosure.

According to embodiments of the present disclosure, the extension jack of an extendable headphone may be used to connect the extendable headphone to another headphone (i.e., a second headphone), by connecting the extension jack to the input jack of the second headphone for amplified playback of the common audio source by the multiple headphones in speaker mode. While reference is made herein to an “output jack” or “extension jack”, the output interface need not be a physical connector and may be practiced by employing a wireless output connection from the extendable headphone to at least a second headphone.

Audio is sent to an output interface (alternately referred to as an extension jack), which may incorporate a physical connector. The audio may be received at the input of another audio playback device. According to an embodiment of the present disclosure, multiple extendable headphones may be connected together in sequence in their respective extension jacks and input jacks, into a “daisy chain” arrangement, wherein each of the multiple extendable headphones maybe converted into speaker mode (i.e., wherein the amplifier is activated by rotating the at least one speaker housing) and connected together to create a “wall of sound”. The wall of sound configuration including a chain of multiple connected extendable headphones converted into speakers enables the internal amplifiers of the respective extendable headphones to compensate for splitting loss and increase the number of headphones that may be connected without sound quality degradation. In addition, to being worn on the ears of the multiple users, the chain of multiple extendable headphones may be placed on a surface to enable the wall of sound playback without restricting the personal movement of the one or more users, no extra cable is needed as in the case with the use of a Y cable with a conventional unamplified headphone.

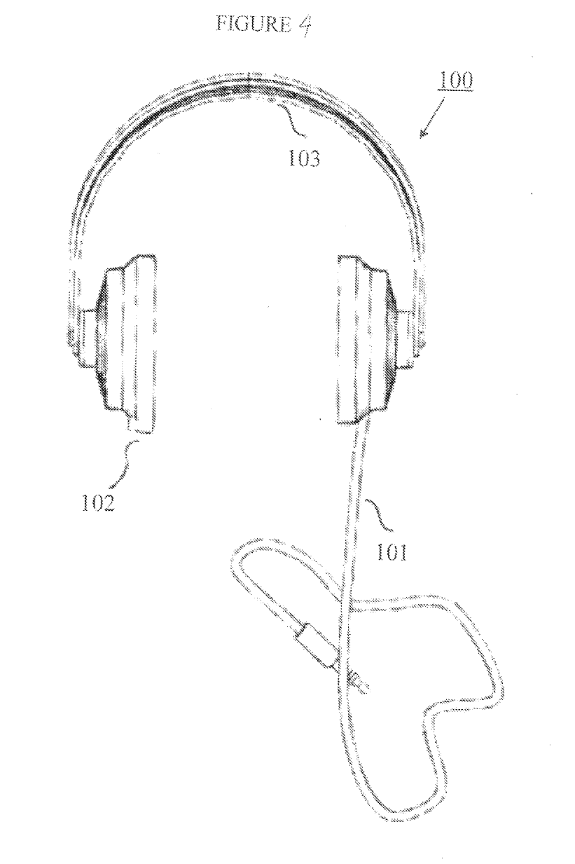

FIG. 4 illustrates extendable headphone 100, according to aspects of the present disclosure. As shown in FIG. 4, the extendable headphone 100 includes an input cable 101, which is connectable to an audio source (e.g., a mobile device, an MP# player, a tablet, any suitable computing device, etc.) The input cable 101 maybe permanently (or hard) wired to a portion of the extendable headphone 100, such as, for example, to one of the speaker portions of the extendable headphone 100 (as shown in FIG. 4). Alternatively, the extendable headphone 100 may include an input jack for coupling with a removable input cable for connection to an audio source. The extendable headphone 100 further includes an extension jack 102 configured to be coupled with another headphone (e.g., another extendable headphone). According to an embodiment of the present disclosure, the audio cable 101 (or input jack) and the extension jack 102 are connected (or wired) in parallel via cables routed through a headband 103 of the extendable headphone 100.

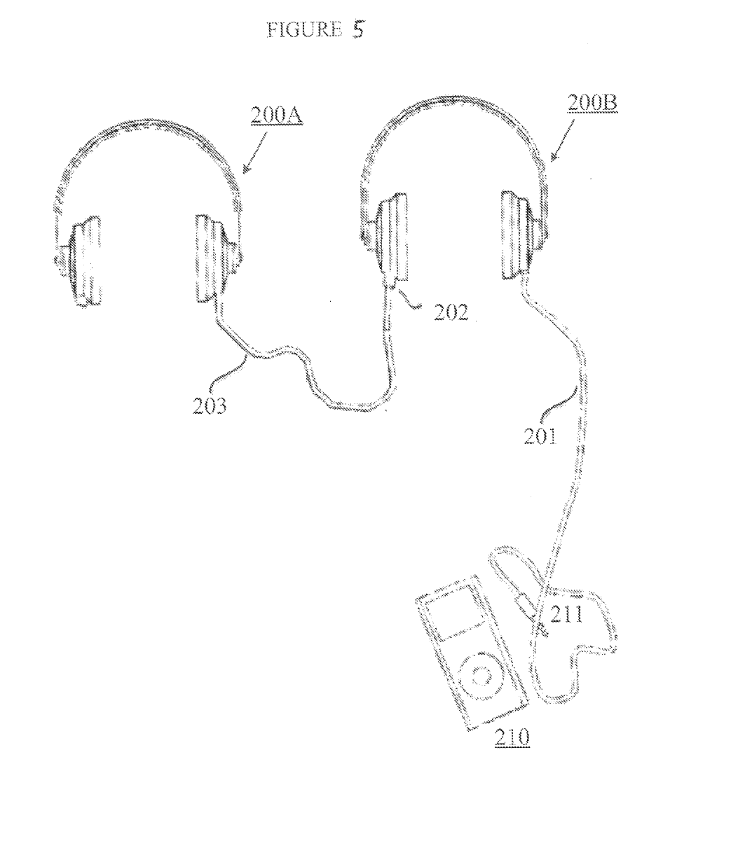

Advantageously, two or more the extendable headphones 100 shown in FIG. 4 may be connected in the wall of sound configuration, wherein the two or more extendable headphones are connected together for playback in the speaker mode (e.g., with the speaker portions of the headphone rotated to activate the externally-directed amplifier). As shown in the exemplary arrangement illustrated in FIG. 5, two extendable headphones (200A and 200B) connected together for playback of audio from a common audio source 210. As shown in FIG. 5, a plug 211 of a first audio cable 201 of headphone 200B is connected to the audio source 210. A second audio cable 203 is used to connect the headphone 200A to an extension jack 202 of headphone 200B.

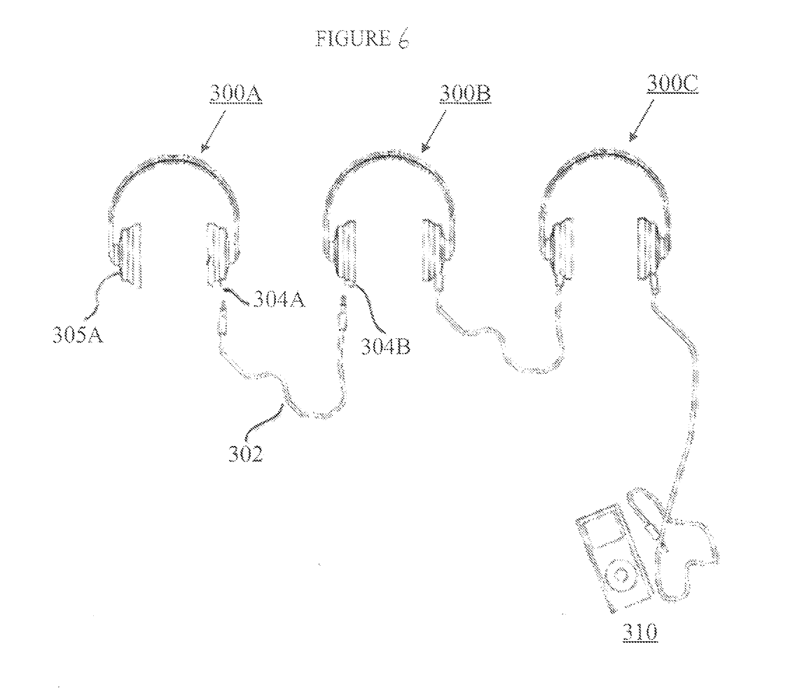

FIG. 6 illustrates multiple exemplary extendable headphones (300A, 300B, and 300C) connected together, wherein a removable audio cable 302 is used to connect headphone 300A and headphone 300B.

In an embodiment, headphone 300A may include two extension jacks (304A and 305A). The two extension jacks 304A, 305A may be arranged on each speaker of the headphone 300A, as shown in FIG. 6. Advantageously, the dual extension jacks 304A, 305A enables user with greater flexibility in the manner in which the headphone 300A is used. For example, a left handed users may prefer to couple the removable cable 302 to extension jack 305A, whereas a right-handed user may prefer to connect the removable cable 302 to extension jack 304A. In an embodiment, a user may store the audio source device (e.g., device 311) in a convenient left jacket pocket, and prefer the removable cable to connect to extension jack 304A so that the cable doesn't drape across the front of the user's body.

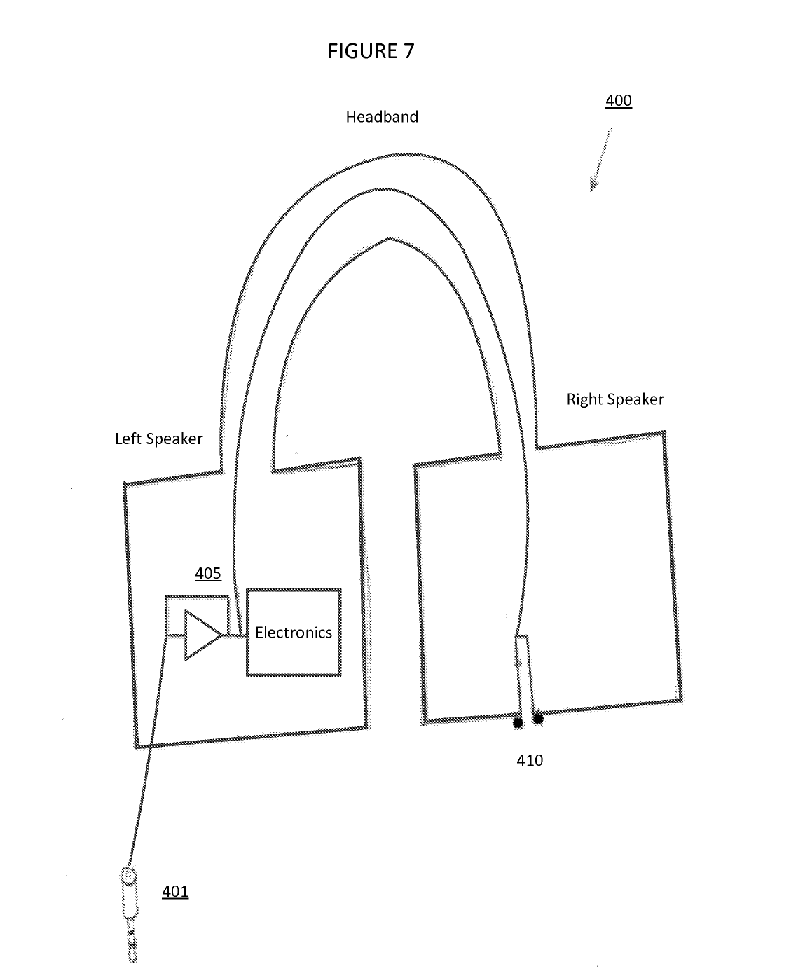

According to an embodiment of the present disclosure, since the extendable headphones includes an internal amplifier which is activated when the output interface or extension jack is used, the amplified headphone compensates for signal degradation which may result from the daisy chaining of multiple headphone by using electrical circuit (herein referred to as a “buffer amp”) to amplify the audio signal before it is passed to an external audio device, such as an adjacent headphone. In an embodiment, the output from a buffer amp is split into multiple signals. One or more of the output signals may incorporate a volume control for level control of that signal with no change to the amplitude of the other signals. FIG. 7 illustrates an exemplary headphone 400 wherein a signal from an audio source transmitted via a fixed cable 401 first passes through a buffer amp 405, which duplicates the original signal while providing more current to drive a headphone connected to its output interface (not shown), such as extension jack 410. The same signal is also used to drive headphone 400′s speakers and power amplifiers. Accordingly, a large number of headphones may be connected together in a daisy chain arrangement, without degrading the quality of the original audio source signal, whether emitting sound as a headphone, as a speaker, or transmitting the signal via the output interface.

According to embodiments of the present disclosure, if the audio cable 401 is removable, the removable audio cable may be mechanically “keyed” to fit into only an extension jack of the left speaker. Once plugged into the extension jack, the headphone operates electronically in the manner described above.

In another embodiment, if the removable audio cable is configured for insertion into the extension jack of either the left or right speaker, the input side of the buffer amp (e.g., buffer amp 405) is routed from the audio input source, while the output of the buffer amp is routed to the opposite extension jack. In this regard, the extendable headphone is configured to differentiate between the input extension jack and the output extension jack of the daisy chained headphone. This allows the user to plug into either jack as an input and use the other jack as an output. Mechanical keying, optical sensing, electronic signal detection, or other means may be employed to detect which plug is being used as the input.

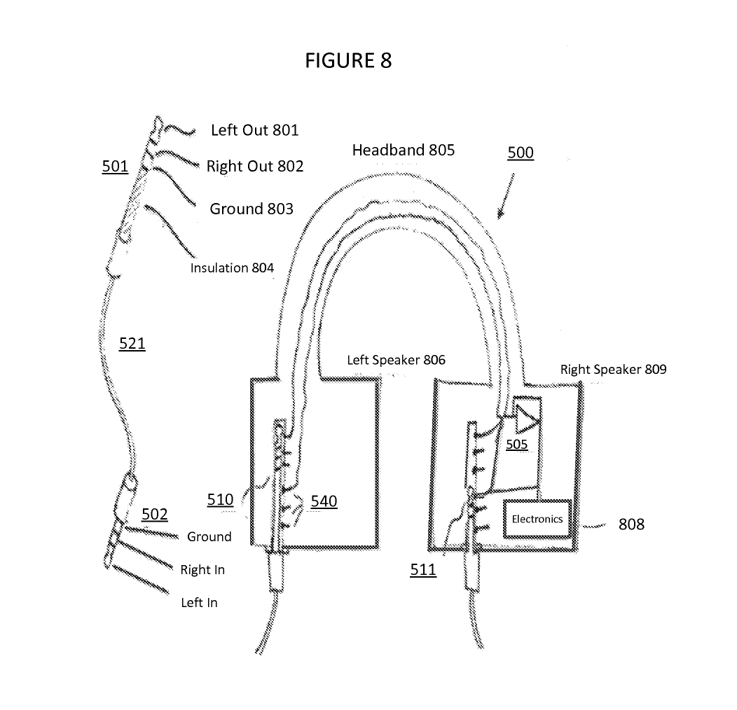

As shown in FIG. 8, in an embodiment, the above-described routing of the audio signal is achieved by configuring an audio plug at a first end of the removable cable which is to be inserted into the headphone 500 to be longer than a conventional plug (e.g., twice as long as a conventional plug). In this arrangement, a tip of the audio lug on the headphone side 501 of a removable cable 521 includes two ends rings configured to carry the audio input signals (e.g., Left Out 801 and Right Out 802). In this embodiment, the long plug 501 is configured to fit into an opening of a conventional audio jack (e.g., extension jacks 510, 511), but the end of the plug 501 bypasses the Left Output, Right Output and ground contacts 540 (e.g., the long plug 501 inserted into extension jack 510 bypasses the Left Output, Right Output and ground contacts 540).

In an example, the longer plug 501 is inserted into extension jack 510 and the short plug 502 is inserted into extension jack 511, as shown in FIG. 5. A buffer amp 505 and electronics 808 are shown in the right speaker 807, for illustration purposes. It is noted that a buffer amp 505 and electronics 808 may be included in the left speaker 806. As shown in FIG. 8, extension jacks 510 and 511 are wired in parallel via wires traversing a headband 805 of the headphone 500 are configured to be deeper than a conventional jack in order to accommodate either plug end (e.g., 501 or 502) of the audio cable 521. The depth of the extension jacks 510, 511 permits the longer plug end 501 to pass by the left, right, and ground contacts 540 of the standard audio jack, and directly connect to buffer amp 505. The output of the buffer amp 505 is routed to the first three contacts of each jack, as well as to the headphone electronics 808.

According to an aspect of the present disclosure, the longer plug 501 inserted into an extension jack 510 carries the audio input signals to the buffer amp 505, while the output signals are accessed by plugging a shorter plug (e.g., plug 502) into the other extension jack (e.g., extension jack 511). Since the extension jacks 510, 511 are wire in parallel, the function and operation of the headphone 500 is unaffected if the longer plug 501 is inserted into either the extension jack 510 of the left speaker housing of the extension jack 511 of the right speaker housing.

According to an embodiment of the present disclosure, the routing described above maybe achieved by using standard audio lugs on both ends of the cable, and including a suitable solid state or electromechanical switching network to reroute the signal appropriately. In an embodiment, the switching network may be triggered by a magnet in the headphone side of the plug, or by other mechanical features In an embodiment, the switching circuit may be configured to reroute the signals if one side of the headphone has a magnet plug but not function if both of neither are magnetic.

What is claimed is:

1. A music playing and listening apparatus comprising:
at least one headband;
at least one speaker;
at least one audio input receiver;
at least one audio output interface;
at least one amplifier; and
at least one power source.

2. The apparatus of claim 1, wherein said audio input receiver is adapted to receive an audio plug.

3. The apparatus of claim 1, wherein said audio input receiver is adapted to receive a wireless signal.

4. The apparatus of claim 1, wherein said audio output interface is adapted to receive an audio plug.

5. The apparatus of claim 1, wherein said audio output interface is adapted to transmit a wireless signal.

6. The apparatus of claim 4, wherein said audio output interface is configured to detect the presence of an external audio device.

7. The apparatus of claim 6, whereupon detection of an external audio device, the amplifier is powered on and the input signal is routed through the amplifier before presentation to the audio output interface.

8. The apparatus of claim 1 wherein the apparatus is a headphone, said headphone having at least two listening modes.

9. A music playing and listening apparatus comprising:
at least one speaker, said speaker having at least two listening modes;
at least one audio input receiver;
at least one audio output interface;
at least one amplifier; and
at least one power source.

10. The apparatus of claim 1, wherein said audio input receiver is adapted to receive an audio plug.

11. The apparatus of claim 1, wherein said audio input receiver is adapted to receive a wireless signal.

12. The apparatus of claim 1, wherein said audio output interface is adapted to receive an audio plug.

13. The apparatus of claim 1, wherein said audio output interface is adapted to transmit a wireless signal.

14. The apparatus of claim 12, where in said audio output interface is configured to detect the presence of an external audio device.

15. The apparatus of claim 14, whereupon detection of an external audio device, the amplifier is powered on and the input signal is routed through the amplifier before presentation to the audio output interface.

16. The apparatus of claim 1 wherein the apparatus is a headphone, said headphone having at least two listening modes.

17. A music playing and listening apparatus comprising:
a headband having opposing ends;
at least two connectors, each of said connectors having at least two arms, a first arm being shorter than a second arm;
at least two speakers, each of said speakers having opposing sides and comprising an audio output element on a first side and a compartment on a second side, said first and second arms of each of said connectors being pivotally attached to a portion of each of said speakers to thereby allow rotation of said speakers, each of said audio output elements of each of said speakers generally face one another during a first music listening mode, each of said speakers being rotatable about said first and second arms of each of said connectors to thereby allow each of said audio output elements of each of said speakers to turn away from one another during a second music playing mode; the rotation of said speakers allowing for changes in modes;
at least one audio input receiver;
at least one audio output interface;
at least one amplifier; and
at least one power source.
